(19) United States
(12) Patent Application Publication
(10) Pub. No.: US 2022/0096288 A1
(43) Pub. Date: Mar. 31, 2022

(54) TRANSFORMABLE ELECTRIC VEHICLE

(71) Applicants: Yu Wen, Chongqing (CN); Jing Wen, Chongqing (CN)

(72) Inventors: Yu Wen, Chongqing (CN); Jing Wen, Chongqing (CN)

(21) Appl. No.: 17/421,013

(22) PCT Filed: Jan. 9, 2020
(86) PCT No.: PCT/CN2020/071126

§ 371 Date: Jul. 6, 2021

(30) Foreign Application Priority Data
Jan. 10, 2019 (CN) 201920035990.0

(51) Int. Cl. A61G 1/017; A61G 5/04; A61G 5/10

(52) U.S. Cl. CPC A61G 1/017; B62D 21/14; A61G 5/1056; A61G 5/04

(57) ABSTRACT

The invention relates to the technical field of electric vehicles, and discloses a transformable electric vehicle. The transformable electric vehicle comprises a chassis, a rear wheel group, a front wheel group located in front of the rear wheel group, transverse retraction rods which can contract or stretch and are arranged transversely, and longitudinal retraction rods which can contract or stretch and are arranged longitudinally; rails are arranged on the lower end face of the chassis, and extend in the length direction of the chassis; one end of the transverse retraction rods is movably connected with the rails, and the other end of the transverse retraction rods is attached to the rear wheel group, the lower ends of the longitudinal retraction rods are fixed to the rear wheel group, and the upper ends of the longitudinal retraction rods are movably connected with the rails; a cushion unit and sliding rails are arranged on the upper end face of the chassis, and the lower end of the cushion unit is attached; the upper end of the cushion unit is movably connected with the sliding rails, and the cushion unit comprises a seat plate for drivers to sit; and when the upper end of the cushion unit is located at the lower parts of the sliding rails, the seat plate is arranged horizontally. The form of the electric vehicle can be switched among different modes according to the requirements of a driver, so that different requirements are met, and the driving experience and safety of the driver are improved.

### TECHNICAL FIELD

The invention relates to the technical field of electric vehicles, in particular to a transformable electric vehicle.

### BACKGROUND ART

The electric vehicle, namely power-driven vehicle, is also called electric drive vehicle; the electric vehicles include AC electric vehicles and DC electric vehicles; the electric vehicles commonly referred to are the vehicles using batteries as an energy source and moved through mechanical energy converted from electric energy via a controller, a motor and other components, and the speed of the vehicle is changed through control over the magnitude of current.

At present, with technological development, people often use the electric vehicles for daily travel, and the electric vehicles are diversified in forms and sizes; and when using the electric vehicle, a driver can stand, sit, lie, etc, so that different driving requirements are met.

In the prior art, an electric vehicle is in a fixed form, and cannot be changed in multiple forms; and for switching among multiple postures, including standing, sitting and lying of the driver, the electric vehicle cannot be changed to the corresponding driving status, and consequently the driving experience and safety of the driver are affected.

### SUMMARY

The invention aims to provide a transformable electric vehicle, with the purpose of solving the problem of a single form of the electric vehicle in the prior art.

The transformable electric vehicle is implemented in such way that the transformable electric vehicle is characterized by comprising a chassis with a lower end face and an upper end face, a rear wheel group, a front wheel group located in, front of the rear wheel group, transverse retraction rods which can contract or stretch and are arranged transversely, and longitudinal retraction rods which can contract or stretch and are arranged longitudinally; rails are arranged on the lower end face of the chassis, and extend in the length direction of the chassis; one end of the transverse retraction rods is movably connected with the rails, and thes other end of the transverse retraction rods is attached to the rear wheel group; the lower ends of the longitudinal retraction rods are fixed to the rear wheel group, and the upper ends of the longitudinal retraction rods are movably connected with the rails; a cushion unit and sliding rails are arranged on the upper end face of the chassis, and the lower end of the cushion unit is attached; the upper end of the cushion unit is movably connected with the sliding rails, and the cushion unit comprises a seat plate for drivers to sit; and when the upper end of the cushion unit is located at the lower parts of the sliding rails, the seat plate is arranged horizontally.

Wherein, the chassis comprises a base and a foot pad, and the foot pad and the base are hinged; in the direction away from advancing, the base is arranged in an arched mode; in the standing state, the foot pad is obliquely arranged upwards away from the ground, and the lower part of the base is connected with the front wheel group; and the upper part of the base extends away from the lower part.

Wherein, the base comprises a support part and a changeover part, and the lower end of the changeover part is connected with the front wheel group; the upper end of the changeover part is hinged to the support part; the cushion unit and the sliding rails are arranged on the upper end face of the changeover part, and the rails are arranged on the lower end face of the changeover part.

Wherein, a locking structure used for fixing the upper part of the seat plate to the chassis relatively is arranged between the seat plate and the chassis.

Wherein, the cushion unit comprises a support plate, and the lower part of the support plate is attached, and the upper part of the support plate is hinged to the lower part of the seat plate; and the upper part of the seat plate is movably connected with the sliding rails.

Wherein, the chassis comprises the base and the foot pad, and the foot pad is installed on a third rotating shaft or at the lower end of the cushion unit.

Wherein, the locking device is arranged on the transformable electric vehicle, and comprises a parking system and a sliding rail locking device.

Wherein, the front wheel group is movably connected with the chassis or the cushion unit.

Wherein, the ends of the transverse retraction rods close to the ground are fixedly connected with or hinged to the rear wheel group.

The invention further provides a transformable electric vehicle comprising a chassis with a lower end face and an upper end face, a rear wheel group, a front wheel group located in front of the rear wheel group, transverse fixing rods or telescopic rods arranged transversely, and longitudinal fixing rods or telescopic rods arranged longitudinally; rails are arranged on the lower end face of the chassis, and extend in the length direction of the chassis; one end of the transverse fixing rods or telescopic rods is movably connected with the rails, and the other end of the transverse fixing rods or telescopic rods is connected with the rear wheel group, the lower ends of the longitudinal fixing rods or telescopic rods are connected with the rear wheel group, and the upper ends of the longitudinal fixing rods or telescopic rods are movably connected with the rails; a cushion unit and sliding rails are arranged on the upper end face of the chassis, the upper end of the cushion unit is movably connected with the sliding rails, and the cushion unit comshion unit is movably connected with the slidprises a seat plate for drivers to sit; and when the upper end of the cushion unit is located at the lower parts of the sliding rails, the seat plate is arranged horizontally.

Compared with the prior art, according to the transformable electric vehicle provided by the invention, through speed difference between front and rear wheels, the rear wheel group, the transverse retraction rods and the longitudinal retraction rods can slide on the rails 90 to change the wheel base; meanwhile, an included angle between the vehicle chassis and the ground is regulated, and the rear wheel position further needs to be locked through locking devices located in rollers 42, so that the stable deformation is achieved. For example:

The driver stands on the chassis. The chassis is arranged longitudinally, and the transverse retraction rods extend properly, so that the distance between the front wheel group and the rear wheel group is increased to ensure that the gravity center of the complete vehicle is located between the front and rear wheels, and the standing mode of the electric vehicle is achieved; when the electric vehicle needs to be switched to the sitting mode, the transverse retraction rods and the longitudinal retraction rods extend properly and separately, and the upper end of the cushion unit is moved to the lower parts of the sliding rails, so that the seat plate is arranged horizontally to adapt to the sitting posture of the driver; when the electric vehicle needs to be switched to the driving mode, one end of the transverse retraction rods is moved on the rails away from the front wheel group, and moved to the farthest position, and meanwhile the transverse retraction rods are contracted to the shortest distance; the upper ends of the longitudinal retraction rods are moved to the farthest position away from the front wheel group, and the longitudinal retraction rods are contracted to the shortest distance; the upper end of the cushion unit is moved to the upper parts of the sliding rails, so that the angle of the chassis is changed to adapt to the running of the vehicle and the driving state of the driver; in this way, the electric vehicle can be switched among different modes according to the requirements of the driver, and different requirements are met; and the driving experience and safety of the driver are improved.

### BRIEF DESCRIPTION OF THE DRAWINGS

FIG. 1 is a stereoscopic view of a transformable electric vehicle provided by the embodiment of the invention;

FIG. 2 is another stereoscopic view of the transformable electric vehicle provided by the embodiment of the invention;

FIG. 3 is a main view of rails of the transformable electric vehicle provided by the embodiment of the invention;

FIG. 4 is a stereoscopic view of the transformable electric vehicle provided by the embodiment of the invention in the standing mode;

FIG. 5 is a stereoscopic view of the transformable electric vehicle provided by the embodiment of the invention in, the sitting mode;

FIG. 6 is a stereoscopic view of the transformable electric vehicle provided by the embodiment of the invention in the driving mode;

FIG. 7 is a stereoscopic view of the transformable electric vehicle provided by the embodiment of the invention in the lying mode.

### DETAILED DESCRIPTION OF THE PREFERRED EMBODIMENTS

In order to make the purpose, technical scheme and advantages of the invention more clear, a detailed description of the invention is given below in combination with the drawings and embodiments. It should be noted that the embodiments described here are only used to explain the invention, but not limited to the invention.

The same or similar labels in the figures of the embodiments correspond to the same or similar components; in the description of the invention, it should be noted that the direction or position relationship indicated by the terms “upper”, “lower”, “left”, “right” and the like are based on the direction or position relationship shown in the figures, only for facilitating description of the invention and simplification of the description, other than indicating or implying that the indicated devices or elements must have the specified direction, are structured and operated in the specified direction; and thus, the terms for describing the position relationship in the figures are only used for exemplary description, but cannot be understood as limitation to the patent, and those skilled in the art can understand the specific meaning of the above terms according to the specific conditions.

The followings are the detailed description on the implementation of the invention in combination with the embodiments.

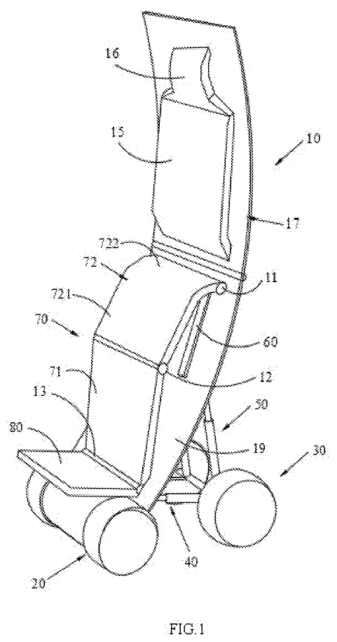

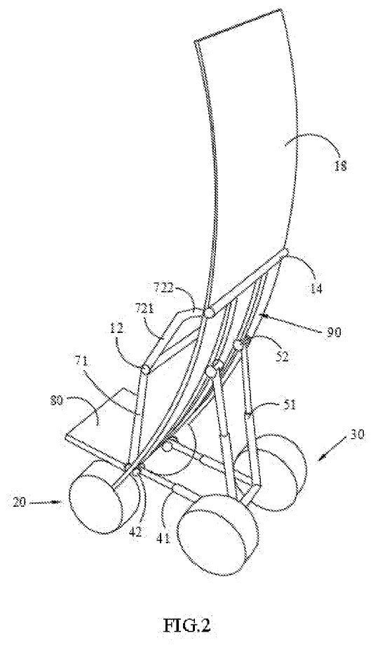

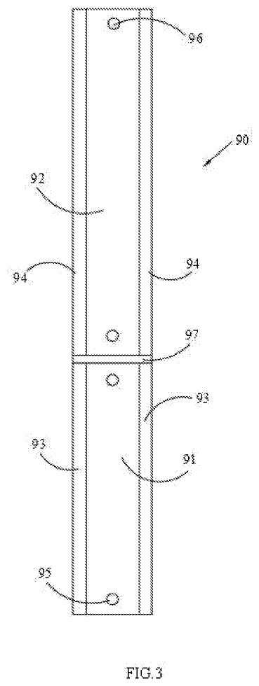

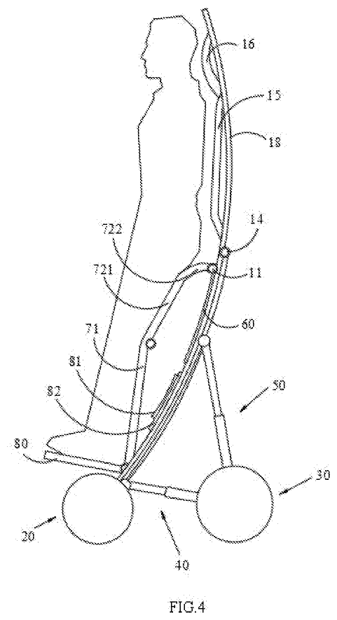

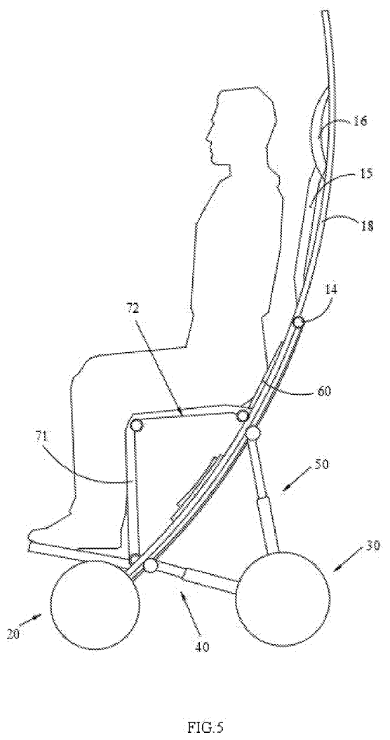

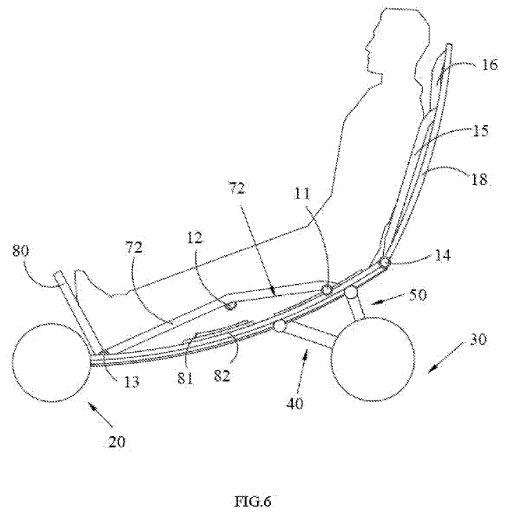

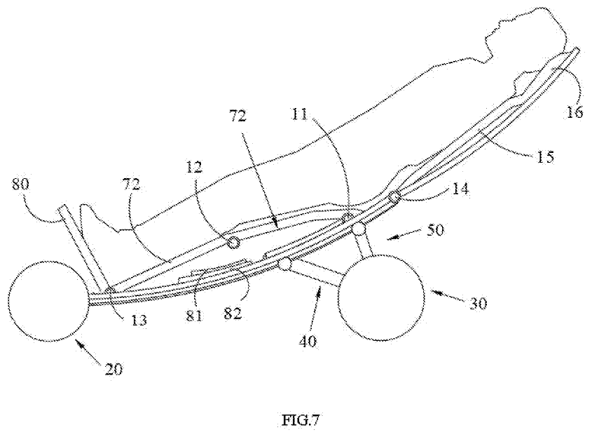

As shown in FIG. 1-7 the optimal embodiments are provided for the invention.

According to the transformable electric vehicle provided by the invention, the problem of a single form of the electric vehicle is solved.

The transformable electric vehicle comprises a chassis 10, a front wheel group 20, a rear wheel group 30, transverse retraction rods 40 and longitudinal retraction rods 50, and an upper end face and a lower end face are arranged on the chassis 10; the front wheel group 20 is located in front of the rear wheel group 30, and the transverse retraction rods 40 can contract or stretch, and are arranged transversely; and the longitudinal retraction rods 50 can be retracted or stretched, and are arranged longitudinally.

Rails 90 are arranged on the lower end face of the chassis 10, and extend in the length direction of the chassis 10; one end of the transverse retraction rods 40 is movably connected with the rails 90, and the other end of the transverse retraction rods 40 is attached to the rear wheel group 30; specifically, the other ends of the transverse retraction rods 40 and the rear wheel group 30 are of a connecting structure assembled together, which may be movable or fixed; the lower ends of the longitudinal retraction rods 50 are fixed to the rear wheel group 30, and the upper ends of the longitudinal retraction rods 50 are movably connected with the rails 90; a cushion unit 70 and sliding rails 60 are arranged on the upper end face of the chassis 10, and the cushion unit 70 comprises a seat plate 72 for the driver to sit. The lower end of the cushion unit 70 is attached, and specifically the lower end of the cushion unit 70 is used in connection with other components, not in a suspended structure; the upper end of the cushion unit 70 is movably connected with the sliding rails 60, and, comprises the seat plate 72 for the driver to sit; and when the upper end of the cushion unit 7Q is located at the lower parts of the sliding rails 60, the seat plate 72 is arranged horizontally.

Specifically, the front wheel group is movably connected with the chassis or the cushion unit, and the ends of the transverse retraction rods close to the ground are fixedly connected with or hinged to the rear wheel group.

According to the transformable electric vehicle provided by the invention, through speed difference between front and rear wheels, the rear wheel group, the transverse refraction rod and the longitudinal retraction rod can be slide on the rails to change the wheel base; and meanwhile, an included angle between the vehicle chassis and the ground is regulated.

When the electric vehicle is in the standing mode, the driver stands on the chassis 10 arranged longitudinally, and the transverse retraction rods 40 extend properly, so that the distance between the front wheel group 20 and the rear wheel group 30 is increased to ensure that the gravity center of the complete vehicle is located between the front and rear wheels, and the standing mode of the electric vehicle is achieved; when the electric vehicle needs to be switched to the sitting mode, the transverse retraction rods 40 and the longitudinal refraction rods 50 extend properly and separately, and the upper end of the cushion unit 70 is moved to the lower parts of the sliding rails 60, so that the seat plate 72 is arranged horizontally to adapt to the sitting posture of the driver; when the electric vehicle needs to be switched to the driving mode, one end of the transverse retraction rods 40 is moved on the rails 90 away from the front wheel group 20, and moved to the farthest position, and meanwhile the transverse retraction rods 40 are contracted to the shortest distance; the upper ends of the longitudinal retraction rods 50 are moved to the farthest position away from the front wheel group 20, and the longitudinal retraction rods 50 are contracted to the shortest distance; the upper end of the cushion unit 70 is moved to the upper parts of the sliding rails 60, so that the angle of the chassis 10 is changed to adapt to the running of the vehicle and the driving state of the driver; in this way, the form of the electric vehicle can be switched among different modes according to the requirements of the driver, and different requirements are met; and the driving experience and safety of the driver are improved.

In order to ensure the safety of the driver, the wheel base and speed at other postures in non-driving modes can be further limited through software in the electric vehicle, so that the optimal wheel base and speed of the electric vehicle can be obtained in different states only. For example:

When the electric vehicle is in the standing mode, the transverse retraction rods 40 extend properly, so that the distance between the front and rear wheels is increased to ensure that the gravity center of the complete vehicle is located between the front and rear wheels, and the stability of the vehicle is ensured. The wheel base adapts to the distribution of the gravity center of the complete vehicle through length regulation of the transverse retraction rods 40; in the standing state, the electric vehicle is limited to the lower speed, so that the driving safety is ensured.

In the sitting mode, the transverse retraction rods 40 are contracted, and the longitudinal retraction rods 50 are contracted, so that the overall gravity center is declined; meanwhile, the upper end of the cushion unit 70 is moved to the lower parts of the sliding rails 60, so that the seat plate 72 is arranged horizontally; under the control of a rotating shaft of the chassis 10, the relative angle between a support part 18 and a changeover part 19 is further changed, and a foot pad 80 is controlled through a foot pad rotating shaft to rotate by a certain angle to adapt to the change of the sitting posture; and in the sitting mode, the vehicle is permitted to run at low speed.

In the driving, mode, one end of the transverse retraction rods 40 is moved on the rails 90 away from the front wheel group 20, and moved to the farthest position, and meanwhile the transverse retraction rods 40 are contracted to the shortest distance; the upper ends of the longitudinal retraction rods 50 are moved to the farthest position away from the front wheel group 20, and the longitudinal retraction rods 50 are contracted to the shortest distance; the upper end of the cushion unit 70 is moved to the upper parts of the sliding rails 60, so that the angle of the chassis 10 and the form of the cushion unit 70 are changed to adapt to the running requirement of the vehicle; and in this mode, the vehicle can reach the highest running speed.

In the lying mode, the angle between the chassis 10 and the seat is closest to the posture that people lay naturally, and in this state, a vehicle walking mechanism is locked through the locking device; the rear wheel position is locked through the locking device so that the stable deformation is achieved.

In this embodiment, the chassis 10 also comprises a base 17 and a foot pad, the foot pad and the base 17 are hinged or installed on the chassis 10, or installed on a third rotating shaft or installed at the lower end of a support plate 71; in different modes of the electric vehicle, the relative angle between the foot pad and the base 17 is deformed to adapt to the requirements of different modes; the base 17 is arranged in an arched mode; and in the standing state, the foot pad is obliquely arranged upwards away from the ground, and the center of gravity is backward, so that the driving safety is improved.

In the embodiment, the lower part of the base 17 is connected with a front wheel group 20, and the upper part of the base 17 extends away from the lower part; and the relative fixation between the base 17 and the front wheel group 20 is achieved, and the base 17 has a support range to ensure that the base plays a role in support of the driver.

Furthermore, the base 17 comprises a support part 18 and a changeover part 19, and the lower end of the changeover part 19 is connected with the front wheel group 20; the upper end of the changeover part 19 is hinged to the support part 18; the cushion unit 70 and the sliding rails 60 are arranged on the upper end face of the changeover part 19, and the rails 90 are arranged on the lower end face of the changeover part 19; the rear wheel group 30 is moved relative to the changeover part 19 through the rails 90, so that the relative angle between the changeover part 19 and a horizontal plane is changed and different modes are switched; in addition, the relative angle between the support part 18 and the changeover part 19 is changed to make the base 17 fit with the driver more properly; and the driving comfort is improved.

A fourth rotating shaft 14 is arranged on the base 17, and the changeover part 19 and the fourth rotating shaft 14 are attached; specifically, the changeover part 19 and the fourth rotating shaft 14 are of a connecting structure assembled together, which may be movable or fixed; the changeover part 19 and the fourth rotating shaft 14 are movably arranged, and the swing, of the changeover part 19 relative to the support part 18 is achieved, so that the angle between the changeover part 19 and the support part 18 is regulated; and the switching between the driving mode and the lying mode is achieved.

A back cushion 15 and a headrest 16 are arranged on the support part 18, and in the forward direction, the back cushion 15 and the headrest 16 are arranged in an arched mode separately; when the driver drives the electric vehicle, the back cushion 15 plays a role in supporting, massaging and protecting the back of the driver, and meanwhile the driving comfort of the driver is improved; and the headrest 16 plays a role in supporting, massaging and protecting the head of the driver, and meanwhile, the driving comfort of the driver is improved.

An inner space is formed between the cushion, unit 70 and the base 17, and a control element 81 and a power supply 82 is arranged in the inner space; the power supply 82 is connected with the control element 81 electrically, and used for providing power to drive the front wheel group and/or the rear wheel group to work; in this way, the electric vehicle is controlled through the control element 81 to run, and the mode switching of the electric vehicle is further controlled through the control eluent 81; and the mode switching accuracy is ensured, and the driving safety is improved.

A detection module of the power supply 82 is arranged on the control element 81, and the functions of charging protection, low voltage protection and discharge over-current protection of the power supply 82 are provided.

The control element 81 is composed of an embedded micro-controller unit (MCU) and a sensor, and all the transverse retraction rods 40, the longitudinal retraction rods 50, the front wheel group 20, the rear wheel group 30 and the like of the electric vehicle are controlled through the MCU; the sensor is used for measuring the running speed, turning speed, acceleration and deceleration of the vehicle, and then feeding back, to the MCU; each device on the vehicle is operated through the MCU according to the control commands of a user, and the vehicle running state is detected according to the sensor data; when, a certain datum or some data of the sensor approach to the design critical value, the vehicle control is actively intervened through the MCU to avoid accidents.

The power supply 82 is a power battery used for power supply to all structures, and the use requirements of the electric vehicle are met.

The front wheel group 20 comprises a plurality of front wheels and steering structures, and the included angle between the wheels and the forward direction of the vehicle is controlled through the steering structures by the control element 81, so that control over the running direction of the electric vehicle is achieved.

The rear wheel group 30 comprises a plurality of rear wheels, a power motor and a braking device, and the power motor is powered by the power supply 82; each rear wheel is driven by the power motor through the control element 81 to rotate, and the running speed and starting of the electric vehicle are controlled; and the rear wheels are braked through the braking device by the control element 81, and the electric vehicle is controlled to stop.

The cushion unit 70 comprises a support plate 71, and the lower part of the support plate 71 is attached; specifically, the lower end of the support plate 71 is used in connection with other components, not in a suspended structure, and is fixedly connected or hinged with the third shaft or foot pad or base; the upper part of the support plate 71 is hinged to the lower part of the seat plate 72, the upper part of the seat plate 72 is movably connected with the sliding rails 60; through change of the included angle between the support plate 71 and the seat plate 72, and cooperation between the seat plate 72 and the sliding rails 60, the form change of the cushion unit 70 is achieved; and the requirements of different modes of the electric vehicle are met.

The first rotating shaft 11 is formed at the upper part of the seat plate 72, and movably connected with the sliding rails 60; and the first rotating shaft 11 is moved relative to the sliding rails 60, and the deformation of the seat plate 72 is achieved.

Locking structures used for relatively fixing the upper part of the seat plate 72 and the sliding rails 60 are arranged on the sliding rails 60, and the locking structures are arranged at the upper parts and lower parts of the sliding rails 60; the locking structures are connected with the control element 81 electrically; and under the effect of the locking structures, the mode fixation is achieved, and wrong switching among the modes is avoided in the using process of the electric vehicle, so that the driving safety is improved.

Each locking structure comprises a locking shaft, and a locking hole is formed in the first rotating shaft 11; the locking shaft is controlled through the control element 81 to move and embed into the locking hole, and the locking of the seat plate 72 is achieved. The locking shafts are installed on the sliding rails 60.

The locking structures can be further composed of a ratchet wheel, toggle piece and the control element which are installed on the seat plate 72 and moved with the seat plate 72, and the toggle piece can be of a needle type, and is connected with the control element 81 through a spring; and the control element 81 can be solenoid valve and the like. When the posture needs to be switched, the toggle; piece is poked through the control element 81; at the moment, the spring is compressed, and the ratchet wheel is electrically controlled to rotate so that the seat plate is driven to move; when the seat plate is moved to the corresponding position, the toggle piece is poked; the toggle piece is pressed into a gear gap of the ratchet wheel under the effect of the spring, and the locking is, finished.

Each rail 90 comprises a longitudinal rod sliding section 92 and a cross rod sliding section 91, and the longitudinal rod sliding section 92 and the cross rod sliding section 91 are arranged in an up-and-down butt joint mode or the cross rod sliding section and the longitudinal rod sliding section are integrally arranged without a block in the middle; one end of the transverse retraction rod 40 is movably connected with the cross rod sliding section 91, and the other end of the transverse retraction rod 40 and the rear wheel group 30 are fixed; specifically, the other end of the transverse retraction rods 40 and the rear wheel group 30 are of a connecting structure assembled together, which may be movable or fixed; the lower end of the longitudinal retraction rod 50 is attached to the rear wheel group 30; the upper end of the longitudinal retraction rod 50 is movably connected with the longitudinal rod sliding section 92; when one end of the transverse retraction rod 40 is located at the upper end of the cross rod sliding section 91, and the upper end, of the longitudinal retraction rod 50 is located at the upper end of the longitudinal rod sliding section 92, the vehicle is in the driving mode; and the movement of the longitudinal retraction rod 50 and the transverse retraction rod 40 is achieved, and the mode switching is achieved.

Furthermore, limiting plates are arranged on the rails 90, and the limiting plates 97 are located between the longitudinal rod sliding section 92 and the cross rod sliding section 91 or two top ends; one end of the transverse retraction rod 40 is limited through the limiting plates to move to the longitudinal rod sliding section 92, and the upper end of the longitudinal retraction rod 50 is limited through the limiting plates to move to the cross rod sliding section 91, or the transverse retraction rod 40 and the longitudinal retraction rod 50 are limited to slide out of the sliding rails; and under the effect of the limiting plates, mutual effect of the longitudinal retraction rod 50 and the transverse retraction rod 40 is avoided effectively, and the mode switching of the electric vehicle is ensured.

Specifically, the locking device is arranged on the transformable electric vehicle, and comprises a parking system and a sliding rail locking device. In the lying state, the parking system can be a common electronic parking system, etc. The front wheel group 20 and the rear wheel group 30 are limited through the locking device to work, and the transformable electric vehicle is in a stopping state; in the lying state, the electric vehicle is in the stopping state, and facilitates the driver to have a rest, and the safety is ensured.

In the embodiment, the first rotating shaft 11 is formed at the upper end of the seat plate 72; the first rotating shaft 11 extends transversely, and the first rotating shaft 11 and the chassis 10 are attached; specifically, the first rotating shaft 11 and the chassis 10 are of a connecting structure assembled together, which may be movable or fixed; and the setting stability of the first rotating shaft 11 is ensured; the sliding rails 60 penetrate through the first rotating shaft 11, and in the longitudinal direction, the first rotating shaft 11 is moved relative to the sliding rails 60, so that switching between horizontal arrangement and oblique arrangement of the seat plate 72 is achieved; and in this way, the deformation of the seat plate 72 is facilitated.

Furthermore, in the transverse direction, locating wheels are arranged at the two ends of the first rotating shaft 11 separately, and two locating grooves are formed in the chassis 10; the two locating wheels are embedded into the two locating grooves separately; and under the cooperation effect of the locating wheels and the locating grooves, the situation that the first rotating shaft 11 is deviated during movement and consequently the deformation of the seat plate 72 is affected is avoided.

The second rotating shaft 12 is arranged at the upper end of the support plate 71, and the lower end of the seat plate 72 is movably connected with the second rotating shaft 12; the second rotating shaft 12 and the first rotating shaft 11 are arranged in parallel; under the effect of the second rotating shaft 12, the relative movement between the support plate 71 and the seat plate 72 is facilitated, thereby facilitating switching between the horizontal arrangement and oblique arrangement of the seat plate 72.

In addition, the second rotating shaft 12 plays a role in strengthening the cushion unit 70, so that the overall structure of the cushion unit 70 is more stable; and the second rotating shaft 12 benefits strengthening of the bearing capability of the cushion unit 70, and the service life of the cushion unit is prolonged.

The seat plate 72 comprises a flat part 721 and a betiding part 722, and the lower end of the flat part 721 is movably connected with the second rotating shaft 12; the lower part of the bending part 722 and the lower end of the flat part 721 are arranged in a butt joint mode; from the lower part of the bending part 722 to the upper part of the bending part 722, the bending, part 722 is bent towards the sliding rails 60 gradually; under the effect of the bending part 722, the driver sits on the seat plate 72, and the gravity center of the driver faces backward to avoid the situation that the driver slides forwards, and consequently the driver is affected to sit on the seat plate 72.

Furthermore, the bending part 722 is arranged in an arched mode outwards; the advantages of such arrangement are that the fitting effect between the bending part 722 and the driver is improved, and the comfort of the driver is improved.

The chassis 10 comprises a foot pad; a third rotating shaft 13 is arranged at the lower end of the support plate 71, and extends transversely; the third rotating shaft 13 and the chassis 10 are attached, and specifically the third rotating shaft 13 and the chassis 10 are of a connecting structure assembled together, which may be movable or fixed; the support plate 71 is rotated around the third rotating shaft. 13 or the third rotating shaft 13 is driven by the support plate 71 to rotate around the chassis 10, and the foot pad is movably connected with the third rotating shaft 13; the relative angle between the foot pad and the support plate 71, and between the support plate 71 and the changeover part 19 is changed through the third rotating shaft 13, so that the foot pad, the support plate 71 and seat plate 72 adapt to different modes, and the use comfort of the electric vehicle is improved. In addition, the foot pad can be further installed at the lower end of the chassis 10 or the lower end of the support plate 71.

The foot pad is obliquely arranged upwards away from the ground, so that the gravity center of the driver faces backwards, and the driving safety of the driver is improved.

The chassis 10 comprises the base 17, and the sliding rails 60 are arranged on the base 17; the lower end of the support plate 71 is attached to the base 17, and the lower end of the support plate 71 and the base 17 are of a connecting structure assembled together, which may be movable; from the lower end of the support plate 71 to the upper end of the support plate 71, the support plate 71 is obliquely arranged away from the base 17 gradually; and through such arrangement, and in different modes, the influence of the support plate 71 on the driver is minimum, and the support plate plays a role in supporting the driver.

The lower end of the support plate 71 and the base 17 are attached, and the support plate 71 is connected with the set position of the lower end of the base 17 through the third rotating shaft 13. The third rotating shaft is installed on the base; the support plate 71 is rotated around the third rotating shaft 13; or the third rotating shaft is installed on the support plate 71, and driven by the support plate 71 to rotate around the chassis 10.

The base 17 is arranged in the arch mode away from the support plate 71; in this way, the distance of the base 17 and the support plate 71 is longer, so that the inner space is larger, and arrangement of the control element 81 and the power supply 82 is facilitated.

In this embodiment, each transverse retraction rod 40 comprises a first roller 42 and a retractable or telescopic first rod body 41, and one end of the first rod body 41 and the first roller 42 are fixed; specifically, one end of the first rod body 41 and the first roller 42 are of a connecting structure assembled together; the other end of the first rod body 41 is attached to the rear wheel group 30; a first mounting groove is formed in the first roller 42; the cross rod sliding section 91 is embedded into the first mounting groove; through stretching and contraction of the first rod body 41, the fine regulation of the distance between the front wheel group 20 and the rear wheel group 30 is achieved, and through the first roller 42 and a second roller 52, the relative movement among the transverse retraction rods 40, the longitudinal retraction rods 50 the tear wheel group 30 and the rails 90 is achieved; under the effect of the first mounting groove, the function of guiding the first roller 42 to move is achieved, and the movement of the first roller 42 is facilitated.

Furthermore, a lower end face is formed on the chassis 10, and the rails 90 are formed on the lower end face of the chassis 10; the first mounting groove comprises two first groove walls arranged oppositely, and a clearance is formed between the two first groove walls; and the cross rod sliding section 91 is located in the clearance, and the first roller 42 is prevented from being deviated during, movement.

In addition, the outer end faces of the first groove walls abut against the lower end face of the chassis 10; in this way, when the first roller 42 is moved, the first groove walls are fit with the lower end face of the chassis 10, and the moving stability of the first roller 42 is improved.

The first groove walls are arranged circularly, and the outer end faces of the first groove walls are arranged in the arched mode outwards; and the movement of the first roller 42 is facilitated, and the friction force of the first groove walls to the lower end face of the chassis 10 is reduced, thereby facilitating movement of the first roller 42.

In order to achieve the locking of the transverse retraction rods 40 and the longitudinal retraction rods 50, sliding rail locking devices are arranged on the first roller 42 and the second roller 52 and in the rail ranges where the first roller and the second roller can slide, and the locking structures between the sliding rails 60 and the seat plate 72 can be further achieved in the same mode, shown as follows:

The first fixing grooves are formed in the two first groove walls, and in the width direction of the cross rod sliding section 91, two first fixing strips 93 are arranged on the cross rod sliding section 91, extend in the length direction of the cross rod sliding section 91, and penetrate through the fixing grooves; through cooperation of the first fixing strips 93 and the first fixing grooves, the situation that the first roller 93 is deviated excessively and consequently the movement of the first roller 42 is affected is avoided; and in addition, under the effect of the first fixing strips, the first roller 42 is prevented from being separated from the chassis 10.

The first mounting grooves comprise the first groove bottoms, and the first reinforcing blocks are arranged at the first groove bottoms; first reinforcing holes 95 are formed in the cross rod sliding section 91; when the first reinforcing blocks are embedded into the first reinforcing holes 95, the first roller 42 and the cross rod sliding section 91 are relatively fixed; through cooperation of a first fixing hole and a first fixing block, the fixing effect of the first roller 42 and the cross rod sliding section 91 is improved, and wrong switching between the modes is avoided; and the driving safety is ensured.

The upper end and the lower end of the cross rod sliding section 91 are each provided with the first reinforcing hole 95; when the electric vehicle is in the standing mode or the sitting mode, the first reinforcing hole 95 in the upper end of the cross rod sliding section 91 is cooperated with the first fixing block, so that the fixation of the standing mode or the sitting mode is achieved, and the use of the standing mode or the sitting mode is ensured; when the electric vehicle is in the driving mode or the lying mode, the first reinforcing, hole 95 in the lower end of the cross rod sliding section 91 is cooperated with the first fixing block, so that the fixation of the driving mode or the lying mode is achieved, and the use of the driving mode or the lying mode is ensured.

Each rail 90 of the electric vehicle structurally comprises the control element 81, and one first groove wall is controlled through the control element 81 to reciprocate towards the other first groove wall for clamping or loosening the cross rod sliding section 91; when the electric vehicle is used, after the mode is selected, the cross rod sliding section 91 is clamped through the two first groove walls, and the relative fixing effect between the first roller 42 and the cross rod sliding section 91 is improved; the use of each mode is ensured; when, the modes are switched, the cross rod sliding section 91 is loosened through the two first groove walls, so that the movement of the first roller 42 is facilitated.

Specifically, each longitudinal retraction rod 50 comprises a second roller 52 and a retractable or telescopic second rod body 51, and one end of the second rod body 51 and the second roller 52 are fixed; the other end of the second rod body 51 is attached to the rear wheel group 30; a second mounting groove is formed in the second roller 52; the longitudinal rod sliding section 92 is embedded into the second mounting groove; through stretching and contraction of the second rod body 51, the regulation of height and angle of the chassis 10 is achieved, and through the second roller 52, the relative movement between the longitudinal retraction rods 50 and the rails 90 is achieved; under the effect of the second mounting groove, the function of guiding the second roller 52 to move is achieved, and the movement of the second roller 52 is facilitated.

Furthermore, the second mounting groove comprises two second groove walls arranged oppositely, and a clearance is formed between the two second groove walls; and the longitudinal rod sliding section 92 is located in the clearance, and the second roller 52 is prevented from being deviated during movement.

In addition, the outer end faces of the second groove walls abut against the lower end face of the chassis 10; in this way, when the second roller 52 is moved, the second groove walls are fit with the lower end face of the chassis 10, and the moving stability of the second roller 52 is improved.

The second groove walls are arranged circularly, and the outer end faces of the second groove walls are arranged outwards in the arched mode; and the movement of the second roller 52 is, facilitated, and the friction force of the second groove walls 10 to the lower end face of the chassis 10 is reduced, thereby facilitating movement of the second roller 52.

The second fixing grooves are formed in the two second groove walls, and in the width direction of the longitudinal rod sliding section 92, two second fixing strips 94 are arranged on the longitudinal rod sliding section 92, extend in the length direction of the longitudinal rod sliding section 92, and penetrate through the fixing grooves; through cooperation of the second fixing strips 94 and the second fixing grooves, the situation that the second roller 52 is deviated excessively and consequently affecting the movement of the second roller 52 is avoided; and in addition, under the effect of the second fixing strips, the second roller 52 is prevented from being separated from the chassis 10.

The second mounting grooves comprise the second groove bottoms, and the second reinforcing blocks are arranged at the second groove bottoms; the second reinforcing holes 96 are formed in the longitudinal rod sliding section 92; when the second reinforcing blocks are embedded into the second reinforcing holes 96, the second roller 52 and the longitudinal rod sliding section 92 are relatively fixed; through cooperation of the second fixing hole and the second fixing block, the fixing effect of the second roller 52 and the longitudinal rod sliding section 92 is improved, and wrong switching between the modes is avoided; and the driving safety is ensured.

The upper and lower ends of the longitudinal rod sliding section 92 are each provided with the second reinforcing hole 96; when the electric vehicle is in the standing mode or the sitting mode, the second reinforcing hole 96 in the lower end of the longitudinal rod sliding section 92 is cooperated with the second fixing block, so that the fixation of the standing mode or the sitting mode is achieved, and the use of the standing mode or the sitting mode is ensured; when the electric vehicle is in the driving mode or the lying mode, the second reinforcing hole 96 in the upper end of the longitudinal rod sliding section 92 is cooperated with the second fixing block, so that the fixation of the driving mode or the lying mode is achieved, and the use of the driving mode or the lying mode is ensured.

One second groove wall is controlled through the control element 81 to reciprocate towards the other second groove wall for clamping or loosening the longitudinal rod sliding section 92; when the electric vehicle is used, after the mode is selected, the longitudinal rod sliding section 92 is clamped through the two second groove walls, and the relative fixing effect between the second roller 52 and the longitudinal rod sliding section 92 is improved; the use of each mode is ensured; when the modes are switched, the longitudinal rod sliding section 92 is loosened through the two second groove walls, so that the movement of the second roller and the switching among the modes are facilitated.

The longitudinal rod sliding section 92 and the cross rod sliding section 91 are integrally arranged, and materials saved; repeated installation is not required, and the installation of the rails 90 is facilitated.

In the width direction of the rails 90, each limiting plate 97 has a transverse distance, and the first roller 42 has a transverse width; the transverse distance of the limiting plate 97 is larger than the transverse width of the first roller 42; it is ensured that each limiting plate 97 has a sufficient limiting range, and the first roller 42 is prevented from entering the longitudinal rod sliding rod 92 or sliding out from the rail 90.

In addition, under the effect of the limiting plates 97, the situation that the second roller 52 enters the cross rod sliding section 91 and consequently the first roller 42 is collided with the second roller 52 is avoided effectively.

A plurality of position sensors are arranged on the electric vehicle, and each position sensor corresponds to each mode; the position sensors are electrically connected with the control element 81 separately, thereby facilitating monitoring of the modes and switching between the modes through the control element 81.

A concave space is formed between the bending part 722 and the back cushion 15; when the driver uses the electric vehicle, and the electric vehicle is in the driving mode or the lying mode, the buttocks of the driver sit in the concave space, and the driving comfort of the driver is improved; and meanwhile the driving safety of the driver is improved.

The front wheel group 20 is movably connected with the chassis 10, so that the fixation of the front wheel group 20 is achieved; the overall stability of the electric vehicle is improved, and the use of the electric vehicle is facilitated; and the use safety is ensured.

The front wheel group 20 is movably connected with the cushion unit 70, so that the fixation of the front wheel group 20 is achieved; the overall stability of the electric vehicle is improved, and the use of the electric vehicle is facilitated; and the use safety is ensured.

The distance between the front wheel group 20 and the footstep of the driver is specific, similarly to pulleys, through driving of the rear wheel group 30, the foot of the driver applies force, and the forward direction of the front wheel group 20 is changed; and the steering and the use of the electric vehicle are achieved, and the driving fun is improved.

The invention further provides another transformable electric vehicle comprising a chassis 10 with a lower end face and an upper end face, a rear wheel group 30, a front wheel group 20 located in, front of the rear wheel group, transverse fixing rods or telescopic rods arranged transversely, and longitudinal fixing rods or telescopic rods arranged longitudinally; rails are arranged on the lower end face of the chassis, and extend in the length direction of the chassis; one end of the transverse fixing rods or telescopic rods is movably connected with the rails, and the other end of the transverse fixing rods or telescopic rods is connected with the rear wheel group; the lower ends of the longitudinal fixing rods or telescopic rods are connected with the rear wheel group, and the upper ends of the longitudinal fixing rods or telescopic rods are movably connected with the rails; a cushion unit and sliding rails are arranged on the upper end face of the chassis, the upper end of the cushion unit is movably connected with the sliding rails, and the cushion unit comprises a seat plate for drivers to sit; and when the upper end of the cushion unit is located at the lower parts of the sliding rails, the seat plate is arranged horizontally. One or two of the transverse retraction rods and the longitudinal retraction rods can be further replaced with the fixing rods, and the fixing rods are fixed-length connecting pieces suspension frames or other devices. In this way, the connecting pieces between the rear wheels and the chassis are more stable, and the service life is longer. The included angle between the transverse retraction rods or fixing rods and the longitudinal retraction rods or fixing rods can be further deformable connection, so that the rear wheel group can obtained a moving space of a larger range.

The above mentioned content is only the preferable embodiments of the invention, and is not limited to the invention. Any modification, equivalent replacement and improvement, permutation and combination, etc. made according to the spirit and principles of the invention shall be included in the protection scope of the invention.

1. A transformable electric vehicle is characterized by comprising a chassis with a lower end face and an upper end face, a rear wheel group, a front wheel group located in front of the rear wheel group, transverse retraction rods which can contract, or stretch and are arranged transversely, and longitudinal retraction rods which can contract or stretch and are arranged longitudinally; rails are arranged on the lower end face of the chassis, and extend in the length direction of the chassis; one end of the transverse retraction rods is movably connected with the rails, and the other end of the transverse retraction rods is attached to the rear wheel group; the lower ends of the longitudinal retraction rods are fixed to the rear wheel group, and the upper ends of the longitudinal retraction rods are movably connected with the rails; a cushion unit and sliding rails are arranged on the upper end face of the chassis, and the lower end of the cushion unit is attached; the upper end of the cushion unit is movably connected with the sliding rails, and the cushion unit comprises a seat plate for a driver to sit; and when the upper end of the cushion unit is located at the lower parts of the sliding rails, the seat plate is arranged horizontally.

2. The transformable electric vehicle according to claim 1, characterized in that the chassis comprises a base and a foot pad, and the foot pad is hinged to the base; in the direction away from advancing, the base is arranged in an arched mode; in the standing state, the foot pad is obliquely arranged upwards away from the ground, and the lower part of the base is connected with the front wheel group; and the upper part of the base extends away from the lower part.

3. The transformable electric vehicle according to claim 2, characterized in that the base comprises a support part and a changeover part, and the lower end of the changeover part is connected with the front wheel group, the upper end of the changeover part is hinged to the support part; and the cushion unit and the sliding rails are arranged on the upper end face of the changeover part, and the rails are arranged on the lower end face of the changeover part.

4. The transformable electric vehicle according to claim 1, characterized in that a locking structure for fixing the upper part of the seat plate to the chassis relatively is arranged between the seat plate and the chassis.

5. The transformable electric vehicle according to claim 4, characterized in that the cushion unit comprises a support plate, and the lower part of the support plate is attached, and the upper part of the support plate is hinged to the lower part of the seat plate; and the upper part of the seat plate is movably connected with the sliding rails.

6. The transformable electric vehicle according to claim 5, characterized in that the chassis comprises the base and the foot pad, and the foot pad is installed on a third rotating shaft or at the lower end of the cushion unit.

7. The transformable electric vehicle according to claim 1, characterized in that a locking device is arranged on the transformable electric vehicle.

8. The transformable electric vehicle according to claim 1, characterized in that the front wheel group is movably connected with the chassis or movably connected with the cushion unit.

9. The transformable electric vehicle according to claim 1, characterized in that the ends of the transverse retraction rods close to the ground are fixedly connected with or hinged to the rear wheel group.

10. A transformable electric vehicle is characterized by comprising a chassis with a lower end face and an upper end face, a rear wheel group, a front wheel group located in front of the rear wheel group, transverse fixing rods or telescopic rods arranged transversely, and longitudinal fixing rods or telescopic rods arranged longitudinally; rails are arranged on the lower end face of the chassis, and extend in the length direction of the chassis; one end of the transverse fixing rods or telescopic rods is movably connected with the rails, and the other end of the transverse fixing rods or telescopic rods is connected with the rear wheel group; the lower ends of the longitudinal fixing rods or telescopic rods are connected with the rear wheel group, and the upper ends of the longitudinal fixing rods or telescopic rods are movably connected with the rails; a cushion unit and sliding rails are arranged on the upper end face of the chassis, the upper end of the cushion unit is movably connected with the sliding rails, and the cushion unit comprises a seat plate for drivers to sit; and when the upper end of the cushion unit is located at the lower parts of the sliding rails, the seat plate is arranged horizontally.
